(19) United States
(12) Patent Application Publication
(10) Pub. No.: US 2012/0063364 A1
(43) Pub. Date: Mar. 15, 2012

(54) NETWORK DISCOVERY

(75) Inventors: Marc Emmelmann, Berlin (DE); Sven Wiethölter, Berlin (DE); Hyung-Taek Lim, Berlin (DE)

(73) Assignee: Technische Universitat Berlin

(21) Appl. No.: 13/298,868

(22) Filed: Nov. 17, 2011

Related U.S. Application Data
(63) Continuation of application No. PCT/EP2010/003774, filed on Jun. 11, 2010.
(60) Provisional application No. 61/186,528, filed on Jun. 12, 2009.

(51) Int. Cl. H04W 84/12

(52) U.S. Cl. 370/255

(57) ABSTRACT

The invention relates to a method for network discovery in a wireless communication network comprising communication devices sending announcement signals regularly with a period being equal to or exceeding a predefined minimum announcement interval, wherein a first communication device
a) communicates with a second communication device during a data exchange phase on a first channel;
b) freezes the communication with the second device by signalling a freezing message terminating the data exchange phase;
c) scans for the announcement signal of third communication devices on a second channel in a scan phase, wherein the scan phase duration is shorter than the minimum announcement interval;
d) unfreezes the communication with the second communication device by signalling an unfreezing message; and
e) repeats steps a) through d).

### BACKGROUND OF THE INVENTION

The invention relates to a method for network discovery in a wireless communication network.

Efficient network discovery is one of the key functional elements for wireless local area networks (WLANs). Hence, its mechanisms and potential improvements have intensively emerged over the last decade. Historically, WLANs simply replaced the wired Ethernet connection for stationary nodes. Communication partners were mostly discovered during the initial power-up phase of the system. Starting with the support of mobile devices, such network discovery occurred more frequently and was even subject to time-constraints if real-time applications, i.e. voice over IP telephone, were to be supported. Still, in the past, such network discovery was a rather seldom occurrence. But this has changed: new application areas as well as the idea of operating unlicensed WLAN devices within licensed frequency bands impose new challenges towards network discovery schemes. The issue on how to scan for new networks at a very high frequency or even how to continuously discover neighboring technologies has to be solved at low cost. Examples for new application areas requiring such frequent network discovery are manifold: 802.11 as the most predominant WLAN technology will move towards the 60 GHz frequency bands [1] and discusses on how to support highly mobile users [2]-[4]. Due to the microcellular architecture in the former and the high handover frequency in the latter case, handover is clearly no longer a seldom occurrence. The same applies to nodes having a software-defined radio interface which enables to constantly choose the network for “best connectivity” and to conduct a handover from one technology to another even during an ongoing communication. Finally, unlicensed devices operating in the “white space spectrum” have to release the media immediately if primary users appear. To assure this, network discovery/spectrum sensing is mandatory according to the FCC rules [5], [6]. One way to assure such primary user detection is to recurrently scan the spectrum. In summary, all those application scenarios require to scan for other devices of the same or different technology continuously or at a high rate while maintaining QoS (QoS: Quality of Service) constraints of the ongoing communication.

### OBJECTIVE OF THE PRESENT INVENTION

An objective of the present invention is to provide a method and a device which allows network discovery with a minimum impact on ongoing communication and quality of service.

### BRIEF SUMMARY OF THE INVENTION

An embodiment of the invention relates to a method for network discovery in a wireless communication network comprising communication devices sending announcement signals regularly with a period being equal to or exceeding a predefined minimum announcement interval, wherein a first communication device
a) communicates with a second communication device during a data exchange phase on a first channel;
b) freezes the communication with the second device by signalling a freezing message terminating the data exchange phase;
c) scans for the announcement signal of third communication devices on a second channel in a scan phase, wherein the scan phase duration is shorter than the minimum announcement interval;
d) unfreezes the communication with the second communication device by signalling an unfreezing message; and
e) repeats steps a) through d).

This embodiment is based on opportunistic scanning and allows continuous network discovery. It may periodically scan for alternative access technologies while upholding QoS constraints in terms of assuring maximum interarrival times of user datagrams. The approach behind opportunistic scanning is that the scanning station may leave its communication channel only for a very short time hence not noticeably affecting the QoS constraints of any higher layer communication. As the dwell time on the scanning channel is very short, opportunistic scanning cannot guarantee to detect an existing technology within a single scanning period. This makes opportunistic scanning a stochastic process with high variability. Though the generic concept of opportunistic scanning may be applied to any wireless technology, it is assumed that an opportunistic scanning scheme is particularly useful for 802.11-based systems. The rational behind this assumption is that 802.11 is the most inexpensive and most widely deployed WLAN technology which is believed will continue to be the predominant technology for WLANs operating in “white space” as well as in unlicensed, higher frequency bands. The realization also adheres to the constraints that any system employing opportunistic scanning should fully comply with the existing 802.11 standard which enables an effortless integration of this novel scheme in existing WLAN chipsets/deployments. Radio frequencies range generally from 30 kHz to 300 GHz. Particularly useful frequency regimes are e.g. from 50 MHz to above 800 MHz for white space communication using television frequencies, the IEEE 802.11 frequency bands at 2.4, 3.6 and 5 GHz, as well as proposed extensions of WLAN technology toward 60 GHz frequency bands. The invention is by no means restricted to these particularly useful frequency regimes, but is valid all communication using electromagnetic waves.

Referring again to the method steps of the embodiment described above, the total duration of freezing, scan phase and unfreezing is preferably smaller than the minimum announcement interval.

The switching between the data exchange and the scan phase may be predetermined by a predefined scan interval. Preferably, the total duration of data exchange and scan phase is smaller than the scan interval.

The second and the third communication device may operate on different physical channels or on the same physical channel.

The second communication device preferably buffers packets to be delivered to the first communication device during the scan phase, and delivers the packets during a subsequent data exchange phase.

The first communication device may freeze the communication, even if packets for delivery to the second communication device are present in its sending buffer or packets from the second communication device to the first communication device are present in the buffer of the second communication device.

Alternatively, the first communication device may freeze the communication, only if the sending buffer of the first communication device and the sending buffer of the second communication device are empty.

Preferably, the freezing message is sent in a null data frame. Alternatively, the freezing message may be sent piggybacked on a data stream packet.

The announcement signal may be a beacon and the minimum announcement interval may be a minimum beacon interval. Alternatively, the announcement signal may be a pilot, a frame header or an energy pattern, and the minimum announcement interval may be a minimum pilot interval, a minimum frame header interval, or a minimum energy pattern interval.

Preferably, the step of scanning the channel is passive.

The first communication device, the second communication device and the third communication device may be IEEE 802.11 WLAN devices, wherein freezing the wireless communication link is carried out using the power save mode sleep procedure and wherein reactivating the wireless communication link is carried out using the power save mode wake-up procedure.

The invention also relates to a communication device capable of network discovery in a wireless communication network comprising devices which send announcement signals regularly with a period being equal to or exceeding a predefined minimum announcement interval, wherein said communication device comprises:

a) a transmitting and a receiving unit adapted to communicate with a second communication device during a data exchange phase on a first channel;

b) a control unit adapted to freeze and unfreeze the communication with the second device by signalling a freezing message terminating the data exchange phase; wherein the receiving unit is configured to scan for the announcement signal of third communication devices on a second channel in scan phases, wherein the scan phase duration is shorter than the minimum announcement interval.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended drawings. Understanding that these drawings depict only typical embodiments of the invention and are therefore not to be considered to be limiting of its scope, the invention will be described and explained with additional specificity and detail by the use of the accompanying drawings in which

FIG. 1 shows a generic opportunistic scanning approach in an exemplary fashion;

FIG. 2 shows a sleep procedure of PSM-STA in an exemplary fashion;

FIG. 3 shows a STA initiated wake-up procedure in an exemplary fashion;

FIG. 4 shoWs a signaling sequence for minimum PSM duration in an exemplary fashion;

FIG. 5 shows the minimum PSM duration in an exemplary fashion;

FIG. 6 shows the calculation of the number of scanning attempts (signaling not shown) in an exemplary fashion;

FIG. 7 shows the probability of receiving a beacon in an exemplary fashion; and

FIG. 8 shows an exemplary embodiment of a communication device capable of network discovery in a wireless communication network.

### DETAILED DESCRIPTION OF THE PREFERRED EMBODIMENT

The preferred embodiment of the present invention will be best understood by reference to the drawings, wherein identical or comparable parts are designated by the same reference signs throughout.

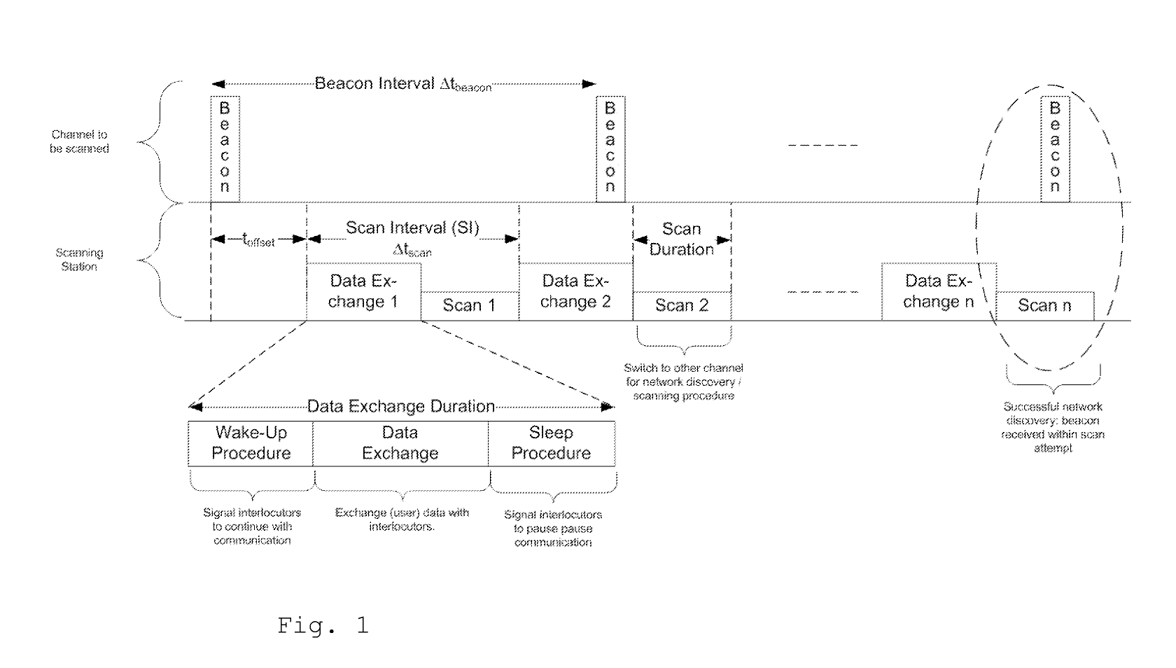

It will be readily understood that the present invention, as generally described and illustrated in the figures herein, could vary in a wide range. Thus, the following more detailed description of the exemplary embodiments of the present invention, as represented in FIGS. 1-8 is not intended to limit the scope of the invention, as claimed, but is merely representative of presently preferred embodiments of the invention.

An exemplary embodiment of the invention will now be explained in further detail, wherein a detailed performance analysis of Opportunistic Scanning using the 802.11 power save to pause any ongoing communication while scanning for other technologies, will be discussed. The following topics will be addressed:
assessing the performance limits while considering implications of the 802.11-architecture and protocol such as delayed beacons and clear channel assessment accounting for random backoff due to a busy media;
comparing results for an idle communication channel to analytically derived performance limits;
evaluating the influence of background traffic on the performance of opportunistic scanning; and
quantifying the cost of opportunistic scanning including a detailed discussion of the introduced protocol overhead.

First, an exemplary embodiment of system model will be introduced followed by a short description of the opportunistic scanning approach and how it may be applied to a 802.11 system using power save as a signaling protocol.

### System Model

A set of 802.11 access points (APs) is considered, each having a high capacity connection to the Internet. These APs may be located at user premises (home networks) or in highly populated urban areas (public hot spots). 802.11 devices have a standard compliant implementation of the MAC but are not necessarily limited to operate only on the 2.4 and 5 GHz frequency band defined in the standard. Hereby, our architecture implicitly allows 802.11-based devices to be run in the “white space” recently opened for unlicensed operation.

No constraints are imposed on the backhaul connection except that we assume that the backhaul's media access is strictly separated from the last hop. This assumption allows a wide range of architectural choices ranging from wired links (e.g., Ethernet), over having heterogeneous (wireless) technologies for the last hop and backhaul (e.g., 802.11 and Wi-MAX), up to using homogeneous technologies on different frequencies (e.g., 802.11b/g vs. 802.11a). This assumption is feasible as backhaul connectivity is usually set up by a service provider which tries to avoid any effects of end-usersystems on its backhaul technology.

Regarding the last hop, each 802.11 AP forms an infrastructure basic service set (BSS). All considered BSSs belong to the same extended service set (ESS). If a BSS does not belong to the same ESS, clients may not use this BSS for roaming. Hence, detecting such BSSs is conceptually identical to the detection of any other technology (e.g. the presence of a primary user for white space operation) which is not used for communication purposes. BSSs may overlap and hence frequently operate on different channels to reduce interference. Also, the coverage area of a BSS may overlap with the one of a secondary technology (e.g. WiMAX or a 3/4G network). We assume that any present technology announces their existence at regular time intervals, e.g. by broadcasting a beacon or frame header. (802.11 or WiMAX) or by a recurring energy pattern which can be identified but not necessarily decoded by the scanning STA (footprint-based detection of primary users in white space).

In our system model, users are 802.11-based stations (STA) located within a BSS and are connected to the Internet via their associated AP. Under the “best-connected network paradigm”, STAs may continuously choose among alternative links, i.e. another 802.11 AP or secondary technology. Thus, they continuously scan in order to detect alternative technologies or evaluate the link properties on other frequencies. Such continuous scanning is also used to detect primary users for white-space operation.

### Opportunistic Scanning Approach

The general concept of opportunistic scanning is driven by the paradigm that seamless connectivity (as seen by the end user) does not mean guaranteeing zero-delay, interruptionfree communication but limiting the duration and frequency of possible interruptions to an upper bound not affecting the QoS constraints of the user application, hence not being noticeable to the user. As a result, our scanning approach is driven by two main constraints:
The approach should enable real-time communication with small packet interarrival times and hard QoS constraints requiring low packet loss and relative small extra delay at MAC. Such applications include, e.g., voice over IP (VoIP) as well as telemetry applications.
Second, the scanning approach shall only passively scan the scanned channel. This assures that opportunistic scanning does scale with the number of stations employing this approach and does not (unproductively) affect any communication on the scanned channel.

The following sections highlight the general idea of the opportunistic scanning approach and show how opportunistic scanning can be applied to an IEEE 802.11 based WLAN.

### General Idea of Opportunistic Scanning

In general, opportunistic scanning aims at periodically leav ing the current communication channel only for a very short time to conduct a scanning procedure as indicated by the scan-intervals (SI) in FIG. 1. The approach hereby assumes that the system/technology to be discovered announces its existence at regular time intervals on the scanned channel Δt_{beacon}. Please note that the term beacon includes any kind of footprint identifying a technology—ranging from a decodable signaling packet (as known from homogeneous technologies, i.e. 802.11) up to a unique energy pattern (whose contents cannot be interpreted but only recognized as known from the primary user detection concept in the white space). Thus, two unique phases comprise the scan interval: a data exchange and a scan phase. In order to avoid packet loss, the former also involves signaling to any interlocutor to pause ongoing transmission (sleep-procedure) before it ends, as well as to continue sending data (wake-up procedure) in its beginning.

Depending on the implementation, opportunistic scanning allows to prioritize either the scanning or the data exchange process. The former guarantees a minimum scan duration and hence stops the data exchange even if user data packets are pending for transmission. Such priority could be given in a white space environment where the upmost goal is detecting the primary user. The latter would always exchange any pending user data packets even at the cost of reducing the scan duration nearly to zero. Thus, this second mode is suitable if QoS-constrained data exchange is valued higher than network discovery and was hence our choice for this embodiment of the invention.

### Application of Opportunistic Scanning to 802.11 WLAN

The power save feature of IEEE 802.11[7] allows a station to signal its interlocutors to hold (and buffer) any pending traffic. Though, it does not deem the signaling station to actually go into power save mode. Hence we herein use this time for passively scanning another channel.

It should be noted that in most common implementations, the “sleeping” station only returns from power save after the reception of a 802.11 beacon which would result in unacceptably long sleeping times. Nevertheless, a rarely used sequence of power save signaling messages allows the station to resume communication at any time. This enables us to use the existing, standard compliant power save feature to apply opportunistic scanning to a 802.11 network. Hereby, a STA signals to the AP that it will go into “sleep mode” for at most n beacon intervals. Nevertheless, the STA may return from its “sleep mode” any time before this period expires.

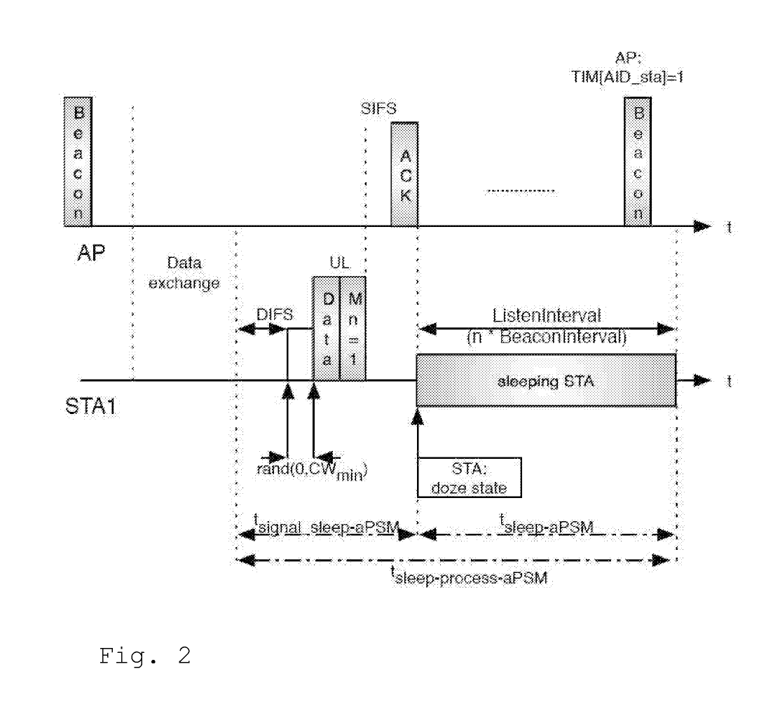

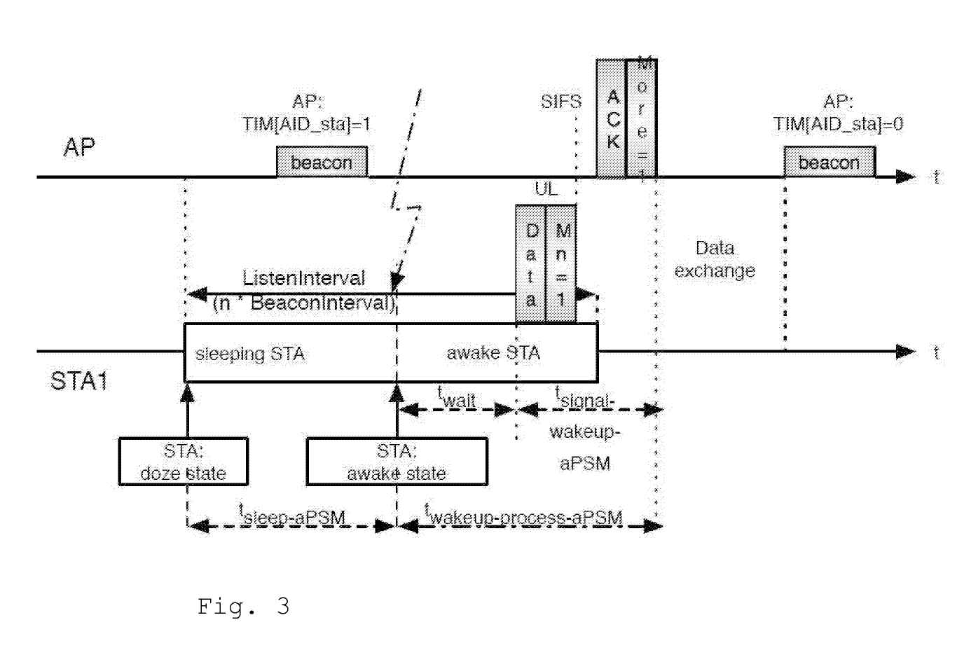

FIGS. 2 and 3 illustrate the resulting protocol details for the wake-up and sleep process. Actually, all the signaling information can be piggy-backed in the transmission of pending up-link data packets. The only overhead for this approach comes if no uplink data is pending—at which a null-data packet has to be transmitted. Also the standard requires power save stations to explicitly request all buffered packets in the downlink using a PS-Poll frame [7]. For the sake of briefness, the reader is referred to [8] for a detailed discussion of the signaling procedure. Therein, the theoretical performance limit of the approach is derived and prime numbers as optimal choices for the scan interval are recommended.

### Performance Evaluation

### Goals and Methodology

In the following we aim at classifying the theoretical performance limits of the opportunistic scanning approach. In particular, we intend to answer the following questions:
How large is the minimum duration just for the whole power save signaling?
How long does it take to find an existing station at a given probability?

Answering the former quantifies the smallest possible turnaround time from data exchange to scanning and back to data exchange if 802.11 power save is used as the underlying signaling protocol. Hence it is a measure for the smallest supportable service interval for user data. The latter in turn assess the time required in the overlap of adjacent cells to successfully complete the topology discovery under the optimistic assumption that the station scans only one channel on which an alternative Mesh AP is known to be found. Also, these results may be used to quantify an upper limit after which the opportunistic scanning process should start its topology discovery on a new channel if no station has been found. In the following, we employ analysis to assess these theoretical limits.

### Scenario

We consider two adjacent mesh nodes having an overlapping coverage area. Both mesh nodes un-synchronously transmit beacons to announce their existence at regular time intervals as defined by the 802.11 standard. The analysis considers the opportunistic scanning station being stationary located within the overlap. It is associated with one of the mesh nodes. Apart from the beacon transmissions and communication between the opportunistic scan station with its associated mesh node, the channel is assumed idle.

### Metrics

Our analysis makes use of the following two metrics: power save mode duration and beacon reception probability. The power save mode duration defines the time from the beginning of the signaling involved to transition from the “awake” into the “doze” and back into the “awake state”. It quantifies the service interruption imposed on the application due to the opportunistic scanning approach. The beacon reception probability quantifies the number of scanning attempts/time required to successfully receive a beacon at a given probability.

### Analytical Results for Idle Channel

### Minimum Power Save Duration

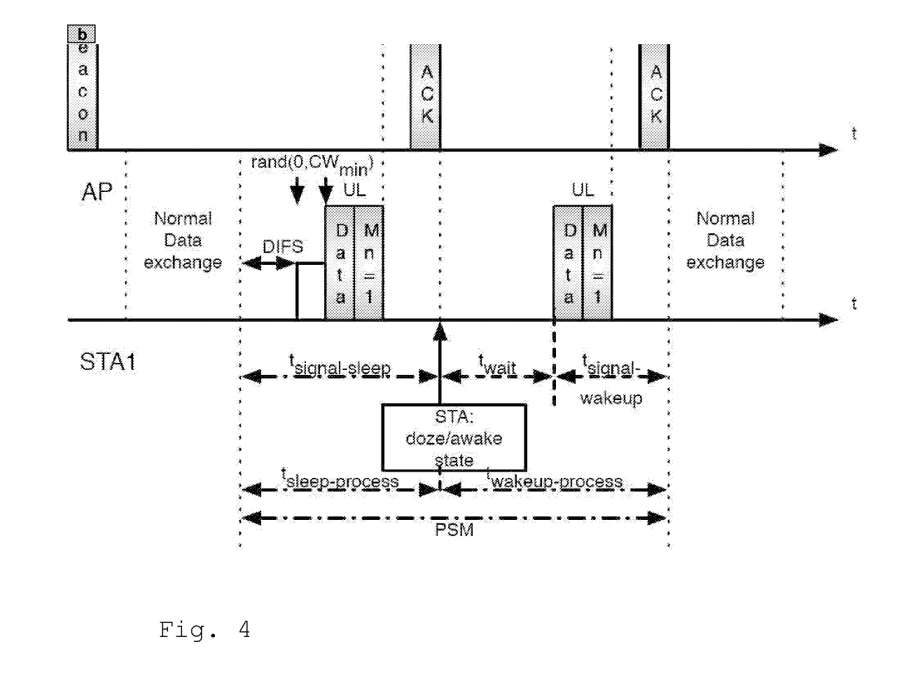

FIG. 4 illustrates the signaling sequence involved in going from “awake” into “doze” and immediately back into “awake state”. As we do not spend any time in the “doze state”, we are actually not conducting any opportunistic scanning at all. This quantifies the smallest possible duration to switch back and forth between channels. In order to hold a specific QoS constraint, the minimum power save duration represents the lower bound for the inter-arrival time of application data at MAC level.

The minimum time spent in power save mode (t_{minPSM}) is given by

$${t}_{minPSM} = {t}_{signal - sleep} + {t}_{wait} ++ {t}_{signal - wakeup} \\ where \\ {t}_{signal - sleep} = {t}_{DIFS} + {rand}_{uniform} ( 0 , cw ) ++ {t}_{DATA - UL} + {t}_{SIFS} + {t}_{ACK} \\ {t}_{wait} = \{ \begin{matrix}{t}_{probeD} , & if channel is idle \\ {t}_{busy} + {t}_{DIFS} ++ {t}_{rand ( 0 , cw ) :} & if channel is busy\end{matrix} \\ {t}_{signal - wakeup} = {t}_{DATA - UL} + {t}_{SIFS} + {t}_{ACK} \qquad ( 1 )$$

Assuming an idle channel, Equation (1) can be directly simplified into

t_{minPSM}=t_{DIFS}+2·t_{SIFS}+2·t_{DATA-UL}++2·t_{ACK}+t_{probeD} (2)

Apart from PHY specific parameters (t_{DIFS}, t_{SIFS}, and t_{probeD}), t_{minPSM} depends on the employed modulation and coding scheme (MCS) for the Data and Acknowledge frame [9].

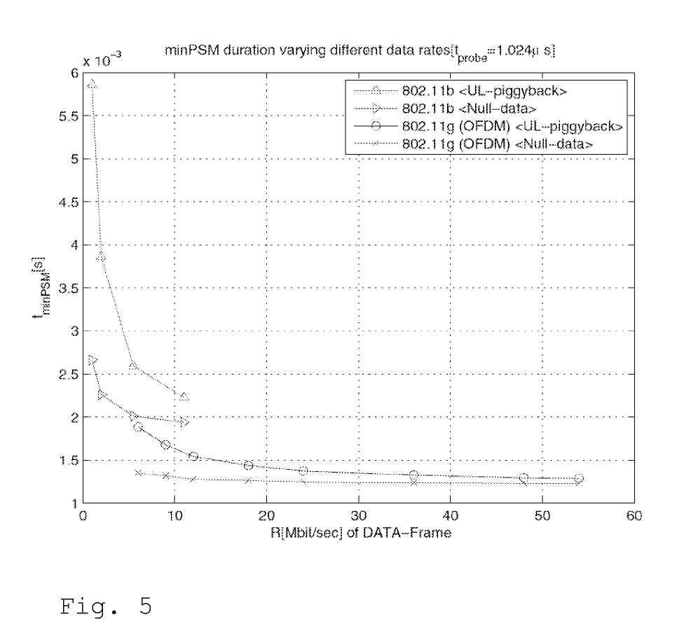

FIG. 5 shows the minimal achievable PSM duration for parameterization and defined MCS for two situations: first assuming that the signaling is transmitted in a Null Data frame, and second, if it is piggy backed in a VoIP data stream packet assuming an underlying G.711 codec and 10 ms packetization without silent suppression. Obviously, the smallest achievable interruption of roughly 1.3 ms occurs for the low-est packet size (Null Data frame) at the highest data rate. But also a 2.6 ms-long interruption at the most robust MCS schemes is acceptable even for hard real time services [10].

Also, the theoretical limits show that opportunistic scanning should be a feasible approach not noticeably affecting VoIP applications as service interruption for piggy backed signaling may be reduced to less than 6 ms for the most robust MCS.

### Required Scan Duration

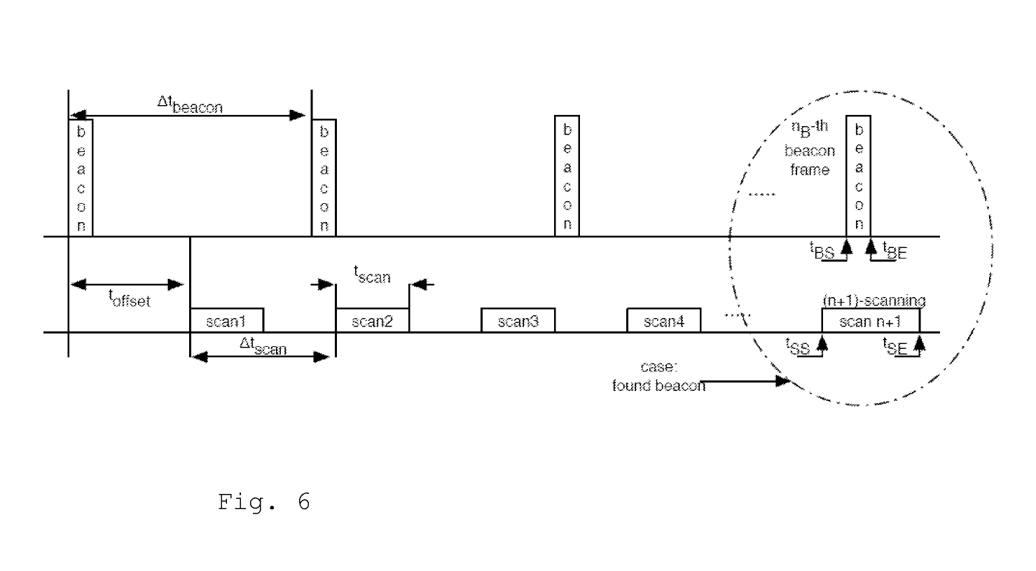

In order to detect a neighboring mesh AP during the nth+1 opportunistic scanning attempt, the beginning of the scanning t_{SS} has to be before the beginning of the beacon reception/start t_{BS} and the end of the scan t_{SE} has to lie after the beacon's end t_{BE} (c.f. FIG. 6):

t_{SS}≦t_{BS} [symbol] t_{BE}≦t_{SE} (3)

Therein,
t_{SS}=t_{offset}+n_{scan}·Δt_{scan}
t_{BS}=n_{beacon}·Δt_{beacon}
t_{BE}=t_{BS}+t_{bencon}
t_{SE}=t_{SS}+t_{scan}
   where t_{offset} is a random variable uniformly distributed over [0,Δt_{beacon}), Δt_{beacon} the target beacon transmission time, Δt_{scan} the scan interval, and t_{scan} the (effective) scan duration remaining after the involved signaling is deducted from the time span given by Δ_{tscan}. Equation 3 can accordingly be rewritten into

$$⋀ \\ \frac{{n}_{beacon} \cdot Δ {t}_{beacon} - {t}_{offset}}{Δ {t}_{scan}} - ( \frac{{t}_{scan} - {t}_{beacon}}{Δ {t}_{scan}} ) \leq {n}_{scan} \\ {n}_{scan} \leq \frac{{n}_{beacon} \cdot Δ {t}_{beacon} - {t}_{offset}}{Δ {t}_{scan}} \qquad ( 4 )$$

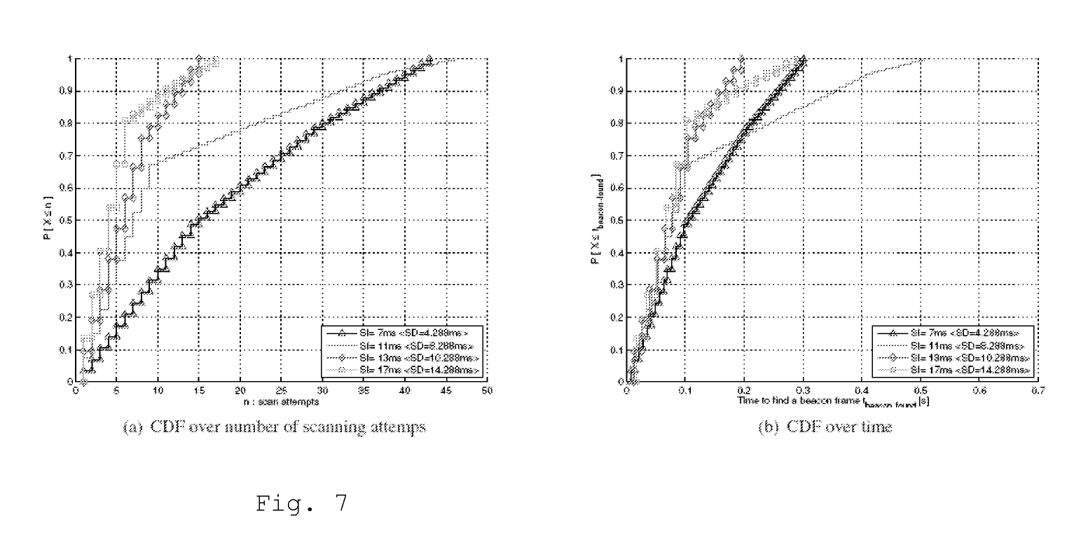

which gives the condition if beacon number m_{beacon} is successfully received within scan attempt n_{scan}. Solving the latter equation numerically and due to the stochastic nature of t_{off-set}, we obtain the probability functions of detecting a beacon at a given scan attempt/after a given time (c.f. FIG. 7).

Obviously, t_{offset} and Δt_{beacon} may not have a common divider to guarantee beacon detection. As we assume that a provider will employ common values with multiples of 10 ms for the target beacon transmission time (e.g., 100 ms) we choose prime numbers for Δt_{scan}. As expected, longer scan intervals yield to better results but interestingly, the effect is less noticeable if one considers the time required to find a beacon as compared to the number of scanning attempt. A topology discovery in two target beacon transmission times (TBTT) is possible. This is only twice the time needed as compared to traditional passive scanning resulting in long service interruptions. But even unsuitable scan intervals resulting in a high duration can accomplish a successful discovery within five TBTTs.

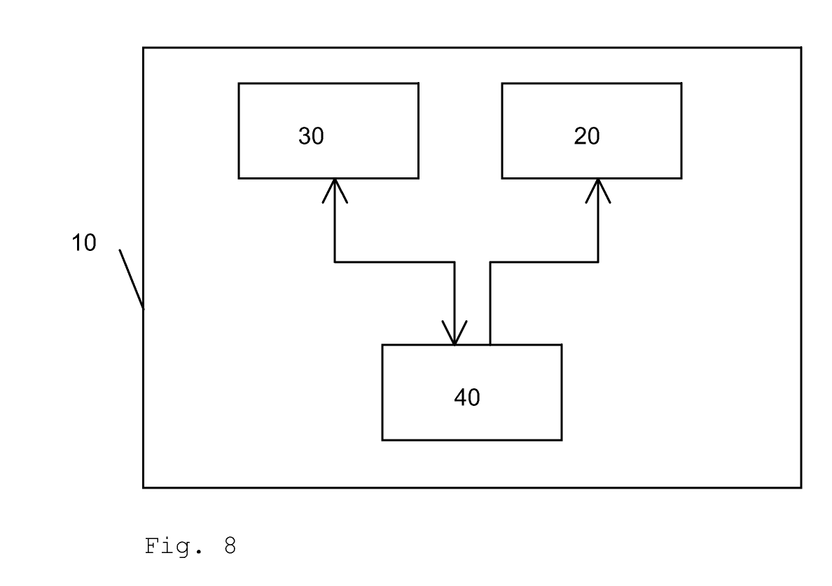

FIG. 8 shows an exemplary embodiment of a communication device 10 capable of network discovery in a wireless communication network comprising devices which send announcement signals regularly with a period being equal to or exceeding a predefined minimum announcement interval. Communication device 10 comprises a transmitting unit 20 and a receiving unit 30 adapted to communicate with a second communication device during a data exchange phase on a first channel. Communication device 10 further comprises a control unit 40 adapted to freeze and unfreeze the communication with the second device by signalling a freezing message terminating the data exchange phase. Receiving unit 30 is configured to scan for the announcement signal of third communication devices on a second channel in scan phases. The scan phase duration is preferably shorter than the minimum announcement interval.

### LITERATURE

[1] E. Perahia, “Vht 60 ghz par plus 5c's,” IEEE 802.11 VHT SG Very High Throughput Study Group, Denver, Colo., USA, doc. 11-08/806, July 2008.
[2] IEEE 802.11p/D6.0—Wireless Access in Vehicular Environments, Draft Amandment to Standard for Information Technology—Telecommunications and Information Exchange Between Systems—LAN/MAN Specific Requirements—Part 11: Wireless Medium Access Control (MAC) and physical layer (PHY) specifications, IEEE Std. 802.11p-2009, Rev. D6.0, March 2009.
[3] H. Morioka and H. Mano, “Broadband access for high speed transportation,” IEEE 802.11 WNG SC Wireless Next Generation Standing Committee, Dallas, Tex., USA, doc. 11-08/1337, Nov. 10-14 2008.
[4] M. Emmelmann, T. Langg\ddot{} artner, and M. Sonnemann, “Fast handover support for highly mobile users using cots 802.11 cards,” IEEE 802.11 WNG SC Wireless Next Generation Standing Committee, Los Angeles, Calif., USA, doc. 11-08/1358, Jan. 19-23 2009.
[5] M. Goldhamer, “Tvbd common functions across ieee 802,” in IEEE 802 White Space Tutorial. IEEE 802 LAN/MAN Standards Committee, March 2009, no. doc.: IEEE sg-whitespace-09/0039r3.
[6] “FCC part 15.711: Interference avoidance mechanisms for telefision band devices, FCC rules for radio frequency devices,” http://www.hallikainen.com/FccRules/2009/15/711/, April 2009.
[7] IEEE 802.11-2007—Wireless LAN Medium Access Control (MAC) and Physical Layer (PHY) Specifications, IEEE Std. 802.11-2007, 2007.
[8] M. Emmelmann, S. Wiethölter, and H.-T. Lim, “Opportunistic scanning: Interruption-free network topology discovery for wireless mesh networks,” in International Symposium on a World of Wireless, Mobile and Multimedia Networks (IEEE WoWMoM), Kos, Greece, Jun. 15-19 2009.
[9] IEEE 802.11-2007—wireless LAN medium access control (mac) and physical layer (phy) specifications, 2007
[10] Virtual Automation Networks Consortium. Real time for embedded automation systems including status and analysis and closed loop real time control. Deliverable D04.1-1, EC Information Society Technology, July 2006.

1. A method for network discovery in a wireless communication network comprising communication devices sending announcement signals regularly with a period being equal to or exceeding a predefined minimum announcement interval, wherein a first communication device
a) communicates with a second communication device during a data exchange phase on a first channel;
b) freezes the communication with the second device by signalling a freezing message terminating the data exchange phase;
c) scans for the announcement signal of third communication devices on a second channel in a scan phase, wherein the scan phase duration is shorter than the minimum announcement interval;
d) unfreezes the communication with the second communication device by signalling an unfreezing message; and
e) repeats steps a) through d).

2. The method of claim 1, wherein the total duration of freezing, scan phase and unfreezing is smaller than the minimum announcement interval.

3. The method of claim 1, wherein the switching between the data exchange and the scan phase is predetermined by a scan interval.

4. The method of claim 3, wherein the total duration of data exchange and scan phase is smaller than the scan interval.

5. The method of claim 1, wherein the second and the third communication device operate on different physical channels.

6. The method of claim 1, wherein the second and the third communication device operate on the same physical channel.

7. The method of claim 1, wherein the second communication device buffers packets to be delivered to the first communication device during the scan phase, and delivers the packets during a subsequent data exchange phase.

8. The method of claim 1, wherein the first communication device freezes the communication, even if packets for delivery to the second communication device are present in its sending buffer or packets from the second communication device to the first communication device are present in the buffer of the second communication device.

9. The method of claim 1, wherein the first communication device freezes the communication, only if the sending buffer of the first communication device and the sending buffer of the second communication device are empty.

10. The method of claim 1, wherein the freezing message is sent in a null data frame.

11. The method of claim 1, wherein the freezing message is sent piggy-backed on a data stream packet.

12. The method of claim 1, wherein the announcement signal is a beacon and the minimum announcement interval is a minimum beacon interval.

13. The method of claim 1, wherein the announcement signal is a pilot and the minimum announcement interval is a minimum pilot interval.

14. The method of claim 1, wherein the announcement signal is a frame header and the minimum announcement interval is a minimum frame header interval.

15. The method of claim 1, wherein the announcement signal is an energy pattern and the minimum announcement interval is a minimum energy pattern interval.

16. The method of claim 1, wherein scanning the channel is passive.

17. The method of claim 1, wherein the first communication device, the second communication device and the third communication device are IEEE 802.11 WLAN devices, wherein freezing the wireless communication link is carried out using the power save mode sleep procedure and wherein reactivating the wireless communication link is carried out using the power save mode wake-up procedure.

18. A communication device capable of network discovery in a wireless communication network comprising devices which send announcement signals regularly with a period being equal to or exceeding a predefined minimum announcement interval, said communication device comprising:
a) a transmitting and a receiving unit adapted to communicate with a second communication device during a data exchange phase on a first channel;
b) a control unit adapted to freeze and unfreeze the communication with the second device by signaling a freezing message terminating the data exchange phase;
wherein the receiving unit is configured to scan for the announcement signal of third communication devices on a second channel in scan phases, wherein the scan phase duration is shorter than the minimum announcement interval.
